(19) United States
(12) Patent Application Publication
(10) Pub. No.: US 2010/0321337 A1
(43) Pub. Date: Dec. 23, 2010

(54) METHOD FOR DETECTING TOUCH POSITION

(75) Inventors: Shih-Yi LIAO, Hsin-Chu (TW); Yao-Jen HSIEN, Hsin-Chu (TW); Heng-Sheng CHOU, Hsin-Chu (TW); Ming-Jong JOU, Hsin-Chu (TW); Hsiang-Yi CHEN, Hsin-Chu (TW)

Correspondence Address: LanWay IPR Services, P.O. Box 220746, Chantilly, VA, 20153, US

(73) Assignee: AU Optronics Corp.

(21) Appl. No.: 12/820,192

(22) Filed: Jun. 22, 2010

(30) Foreign Application Priority Data
Jun. 22, 2009 (TW) 098120894

(51) Int. Cl. G06F 3/045

(52) U.S. Cl. 345/174

(57) ABSTRACT

An exemplary method for detecting touch position includes the steps of: detecting a plurality of sensing points, obtaining at least one first signal and a plurality of second signals on the sensing points, wherein the at least one first signal each has an energy above a preset threshold, the second signals each has an energy below the preset threshold, positions of the sensing points where the second signals being detected are successive with a position(s) of the sensing point(s) where the at least one first signal being detected; performing a weighted averaging operation applied to the energies of the at least one first signal and the second signals and taking a result of the weighted averaging operation as a first dimension coordinate of a touching point, wherein weights of the respective energies are associated with the positions of the sensing points where the at least one first signal and the second signals being detected.

### CROSS-REFERENCE TO RELATED APPLICATIONS

This application is based upon and claims the benefit of priority from the prior Taiwan Patent Application No. 098120894, filed Jun. 22, 2009, the entire contents of which are incorporated herein by reference.

### BACKGROUND

1. Field of the Invention

The present invention generally relates to touch detection methods, and more particularly to a method for detecting touch position that can obtain quite accurate coordinates of one or more touching points.

2. Description of Prior Art

Nowadays, touch panels have been increasingly widely used in electronic devices for inputting information, such as control commands. A user may input commands for writing letters, scrolling windows and virtual keys, only by an object (such as one's finger, a touch pen, etc.) touching or sliding on a touch panel to caught a relative shift or an absolute coordinates shift of a cursor. For example, a capacitive touch panel can be used by a user moving his/her finger(s) on the smooth panel, so as to control a shift of the cursor. When the user's finger touches the panel, energies in a first sensing direction and a second sensing direction of a touching point may be changed. The obtained energies can be used for determining if the capacitive touch panel is touched by an object and for calculating the position coordinates of the touching point. In addition, the capacitive touch panel is so thin that it can be configured in a super-thin notebook, keypad, digital player and another electronic device. The capacitive touch panel is easy to maintain due to its non-mechanical design, thus, the capacitive touch panel is popular and widely used.

Besides, there are also many other touch detection methods for single-touch panels and multi-touch panels. However, the output coordinates of a touching point of the present methods for detecting touch position may be not accurate enough to meet the users' requirement of high touch detection accuracy. Therefore, there is room for improvement within the art of the method for detecting touch position.

### SUMMARY

One objective of the present invention is to provide a method for detecting touch position that can obtain quite accurate coordinates of one or more touching point.

In a first aspect of an embodiment of the present invention, a method for detecting touch position comprises steps of: detecting a plurality of first sensing points for obtaining at least one first signal and a plurality of second signals on the first sensing points, wherein the at least one first signal each has an energy above a first preset threshold, the second signals each has an energy below the first preset threshold, positions of the first sensing points where the second signals being detected are successive with a position(s) of the sensing point(s) where the at least one first signal being detected; and performing a weighted averaging operation applied to the energies of the at least one first signal and the second signals and taking a result of the weighted averaging operation as a first dimension coordinate of a touching point, wherein weights of the respective energies of the at least one first signal and the second signals are associated with the positions of the first sensing points where the at least one first signal and the second signals being detected.

According to the first aspect, the weights of the energies of the at least one first signal and the second signals are in a descending order or an ascending order according to the precedence of the positions of the first sensing points where the at least one first signal and the second signals being detected.

According to still the first aspect, the positions of the first sensing points where the plurality of second signals being detected are at both sides of the position(s) of the first sensing point(s) where the at least one first signal being detected. Further, the positions of the first sensing points where the second signals being detected have an equal number at both sides of the position(s) of the first sensing point(s) of the at least one first signal.

According to yet the first aspect, the method for detecting touch position further comprises steps of: detecting a plurality of second sensing points for obtaining at least one third signal and a plurality of fourth signals on the second sensing points, wherein the at least one third signal each has an energy above a second preset threshold, the fourth signals each has an energy below the second preset threshold, positions of the second sensing points where the fourth signals being detected are successive with a position(s) of the second sensing point(s) where the at least one third signal being detected; and performing a weighted averaging operation applied to the energies of the at least one third signal and the fourth signals and taking a result of the weighted averaging operation as a second dimension coordinate of a touching point, wherein weights of the respective energies of the at least one third signal and the fourth signals are associated with the positions of the second sensing points where the at least one third signal and the fourth signals being detected.

According to above method, the weights of the energies of the at least one third signal and the fourth signals are in a descending order or an ascending order according to the precedence of the positions of the second sensing points where the at least one third signal and the fourth signals being detected.

According to above method, the positions of the second sensing points where the fourth signals being detected are at both sides of the position(s) of the second sensing point(s) where the at least one third signal being detected. Further, the positions of the second sensing points where the fourth signals being detected have an equal number at both sides of the position(s) of the second sensing point(s) of the at least one third signal.

In a second aspect, a method for detecting touch position comprises steps of: detecting a plurality of first sensing points, obtaining a plurality of first signals on the first sensing points, wherein first signals each has an energy above a first preset threshold; sorting the first signals into a plurality of first groups, wherein the first sensing points where the first signals being detected having successive positions are sorted into a same group, and the first sensing points where the first signals being detected having non-successive positions are sorted into another group; and performing a weighted averaging operation applied to the energies of each of the first groups and a plurality of second signals having energies below the first preset threshold, and taking a result of the weighted averaging operation as a first dimension coordinate of one of a plurality of touching points, wherein positions of the first sensing points where each of the first groups being detected are successive with the positions of the first sensing points where the second signals of the first groups being detected, and weights of the respective energies of each of the first groups and the corresponding second signals of the first groups are associated with the positions of the first sensing points where the first groups and the second signals being detected.

According to the second aspect, the weights of the energies of each first group and the corresponding second signals of the first group are in a descending order or an ascending order according to the precedence of the positions of the first sensing points where the first groups and the second signals being detected.

According to still the second aspect, the positions of the first sensing points where the corresponding second signals of one of the first groups being detected are at both sides of the positions of the first sensing points where the first group being detected. Further, the positions of the first sensing points where the corresponding second signals of one of the first groups being detected have an equal number at both sides of the positions of the first sensing points where the first group being detected.

According to yet the second aspect, the method for detecting touch position further comprises steps of: detecting a plurality of second sensing points for obtaining a plurality of third signals on the second sensing points, wherein third signals each has an energy above a second preset threshold; sorting the third signals into a plurality of second groups, wherein the second sensing points where the third signals being detected having successive positions are sorted into a same group, and the second sensing points where the third signals being detected having non-successive positions are sorted into another group; and performing a weighted averaging operation applied to the energies of each of the second groups and a plurality of corresponding fourth signals having energies below the second preset threshold, and taking a result of the weighted averaging operation as a second dimension coordinate of one of a plurality of touching points, wherein positions of the second sensing points where each of the second groups being detected are successive with the positions of the second sensing points where the corresponding fourth signals of the second groups being detected, and weights of the respective energies of each of the second groups and the corresponding fourth signals of the second groups are associated with the positions of the second sensing points where the second groups and the corresponding fourth signals being detected.

According to above method, the weights of the energies of each second group and corresponding fourth signals of the second group are in a descending order or an ascending order according to the precedence of the positions of the second sensing points where the second groups and the corresponding fourth signals being detected.

According to above method, the positions of the second sensing points where the corresponding fourth signals of one of the second groups being detected are at both sides of the positions of the second sensing points where the second group being detected. Further, the positions of the second sensing points where the corresponding fourth signals of one of the second groups being detected have an equal number at both sides of the positions of the second sensing points where the second group being detected.

In a third aspect, a method for detecting touch position comprises steps of: detecting a plurality of first sensing points for obtaining a plurality of first signal groups on the first sensing points, wherein each of the first signal groups includes at least one first signal and a plurality of corresponding second signals, the at least one first signal each has an energy above a first preset threshold, the corresponding second signals each has an energy below the first preset threshold, positions of the first sensing points where the corresponding second signals of each first signal group being detected are successive with a position(s) of the sensing point(s) where the at least one first signal being detected; and performing a weighted averaging operation applied to the energies of the at least one first signal and the corresponding second signals of each first signal group and taking a result of the weighted averaging operation as a first dimension coordinate of one touching point of a plurality touching points, wherein weights of the respective energies of the at least one first signal and the corresponding second signals of each first signal group are associated with the positions of the first sensing points where the at least one first signal and the corresponding second signals being detected. Further, if the number of the at least one first signal is more than two, the positions of the first sensing points where the more than two first signals being detected are successive.

According to the third aspect, the weights of the energies of the at least one first signal and the corresponding second signals of each of the first signal groups are in a descending order or an ascending order according to the precedence of the positions of the first sensing points where the at least one first signals and the corresponding second signals of the first signal groups.

According to the third aspect, the method for detecting touch position further comprises steps of: detecting a plurality of second sensing points for obtaining a plurality of second signal groups on the first sensing points, wherein each of the second signal groups includes at least one third signal and a plurality of corresponding fourth signals, the at least one third signal each has an energy above a second preset threshold, the corresponding fourth signals each has an energy below the second preset threshold, positions of the second sensing points where the corresponding fourth signals of each second signal group being detected are successive with a position(s) of the sensing point(s) where the at least one third signal being detected; and performing a weighted averaging operation applied to the energies of the at least one third signal and the corresponding fourth signals of each second signal group and taking a result of the weighted averaging operation as a second dimension coordinate of one touching point of a plurality touching points, wherein weights of the respective energies of the at least one third signal and the corresponding fourth signals of each second signal group are associated with the positions of the second sensing points where the at least one third signal and the corresponding fourth signals being detected. Further, if the number of the at least one third signal is more than two, the positions of the second sensing points where the more than two third signals being detected are successive.

According to still the third aspect, the weights of the energies of the at least one third signal and the corresponding fourth signals of each of the second signal groups are in a descending order or an ascending order according to the precedence of the positions of the second sensing points where the at least one third signals and the corresponding fourth signals of the second signal groups.

The exemplary embodiments of the present invention has a preset threshold, when a signal having energy above the preset threshold being sensed, the signal together with the other signal(s) that having energy below the preset threshold and having sensing points being detected successive with the sensing points of the signal may be applied for a weighted average operation to calculate the coordinates of a single touching point, thus, the obtained result should be quite accurate. Besides, the exemplary embodiment of the present invention can also be used for calculating the coordinates of two or more touching points by applying groups and weights, thus, the exemplary embodiment of the present invention is applicable for detection of multi-touching points.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a diagram of energies of multi-sensing points in single-touch mode of a method for detecting touch position in accordance with an exemplary embodiment;

FIG. 2 is a diagram of energies of multi-sensing points in multi-touch mode of a method for detecting touch position in accordance with the exemplary embodiment.

### DETAILED DESCRIPTION

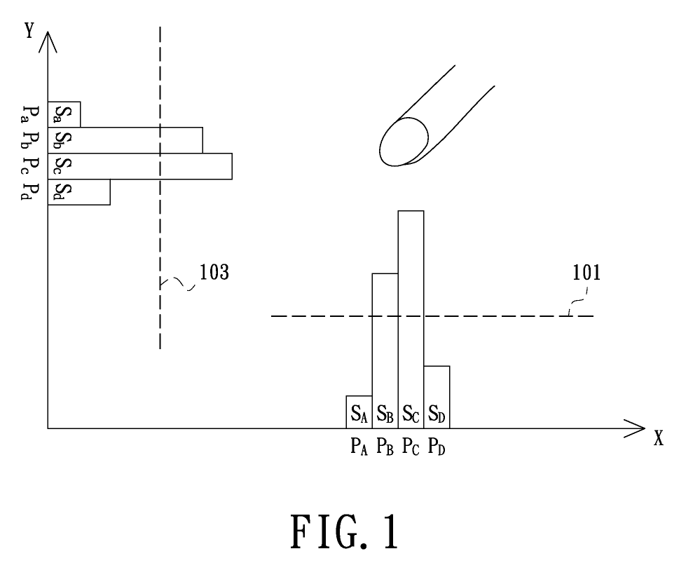

FIG. 1 shows the energies distribution of multi-sensing points in single-touch mode of an exemplary method for detecting touch position. In FIG. 1, P_{A}, P_{B}, P_{C} and P_{D} respectively represent the positions of sensing points in alphabetical order from A through D in a sensing direction X. The positions of sensing points in alphabetical order from A through D respectively correspond to the sensing channels in alphabetical order from A through D in sensing direction X. The positions P_{A}, P_{B}, P_{C} and P_{D} are located and detected in succession. S_{A}, S_{B}, S_{C} and S_{D} respectively represent energies on the sensing points in alphabetical order from A though D in a sensing direction X. Similarly, Pₐ, P_{b}, P_{c} and P_{d} respectively represent the positions of sensing points in alphabetical order from a through d in a sensing direction Y. The positions of sensing points in alphabetical order from a through d respectively correspond to the sensing channels in alphabetical order from a through d in sensing direction Y. The positions Pₐ, P_{b}, P_{c} and P_{d} are located and detected in succession. Sₐ, S_{b}, S_{c} and S_{d} respectively represent energies on the sensing points in alphabetical order from a though d in sensing direction Y.

As shown in FIG. 1, the signals detected on P_{B} and P_{C} in sensing direction X respectively have energies S_{B} and S_{C} both above a preset threshold 101, the signals detected on P_{B} and P_{C} are described as first signals. In sensing direction X, the positions P_{B} and P_{C} of the sensing points where the first signals being detected are successive with each other. To calculate X-coordinate of the touching point, energies S_{A}, S_{D} of the signals being detected on P_{A}, P_{D} and besides P_{B} and P_{C} are taken as weights for calculation. The signals detected on P_{A} and P_{D} respectively having energies S_{A} and S_{D} both below the preset threshold 101 are described as second signals. The first signals and the second signals corresponding to energies S_{A}, S_{B}, S_{C} and S_{D} together form a signal group. The X-coordinate of the touching point can be calculated by an expression (1.1): (S_{A}×P_{A}+S_{B}×P_{B}+S_{C}×P_{C}+S_{D}×P_{D})/(S_{A}+S_{B}+S_{C}+S_{D}). According to the expression (1.1), in sensing direction X, the weights of energies S_{B}, S_{C} of the first signals and S_{A}, S_{D} of the second signals are associated with the positions P_{A}, P_{B}, P_{C} and P_{D} of the sensing points of the first signals and the second signals, and the positions P_{A}, P_{B}, P_{C} and P_{D} of the sensing points where the first signals and the second signals being detected are sorted in a descending order or an ascending order according to the of the precedence of positions of the sensing points where the first signals and the second signals being detected. That is, the value of the P_{A}, P_{B}, P_{C} and P_{D} are sorted in a descending order or an ascending order. In addition, the positions P_{A}, P_{D} of the sensing points where the second signals being detected in sensing direction X are located at both sides of the positions P_{B}, P_{C} of the sensing points where the first signals being detected in sensing direction X. The sensing points where the second signals being detected have an equal number at both sides of the sensing points where the first signals being detected in sensing direction X.

Referring to FIG. 1 again, the signals on P_{b} and P_{c} in sensing direction Y respectively having energies S_{b} and S_{c} both above a preset threshold 103 are described as first signals. In sensing direction Y, the positions P_{b} and P_{c} of the sensing points where the first signals being detected are successive with each other. To calculate Y-coordinate of the touching point, energies Sₐ, S_{d} of the signals on Pₐ, P_{d} and besides P_{b} and P_{c} are taken as weights for calculation. The signals on Pₐ and P_{d} respectively having energies Sₐ and S_{d} both below the preset threshold 103 are described as second signals. The first signals and the second signals corresponding to energies Sₐ, S_{b}, S_{c}, and S_{d} together form a signal group. The Y-coordinate of the touching point can be calculated by an expression (1.3): (Sₐ×Pₐ+S_{b}×P_{b}+S_{c}×P_{c}+S_{d}×P_{d})/(Sₐ+S_{b}+S_{c}+S_{d}). According to the expression (1.3), in sensing direction Y, the weights of energies S_{b}, S_{c} of the first signals and Sₐ, S_{d} of the second signals are associated with the positions Pₐ, P_{b}, P_{c} and P_{d} of the sensing points where the first signals and the second signals being detected, and the positions Pₐ, P_{b}, P_{c} and P_{d} of the sensing points where the first signals and the second signals being detected are sorted in a descending order or an ascending order according to the precedence of the positions of the sensing points where the first signals and the second signals being detected. That is, the value of the Pₐ, P_{b}, P_{c} and P_{d} are sorted in a descending order or an ascending order. In addition, the positions Pₐ, P_{d} of the sensing points where the second signals being detected in sensing direction Y are located at both sides of the positions P_{b}, P_{c} of the sensing points where the first signals being detected in sensing direction Y. The sensing points where the second signals being detected have an equal number at both sides of the sensing points where the first signals being detected in sensing direction Y.

As per descriptions above, a two-dimensional coordinate of a single touching point, that is, the X-coordinate and Y-coordinate of the touching point in the embodiment can be obtained.

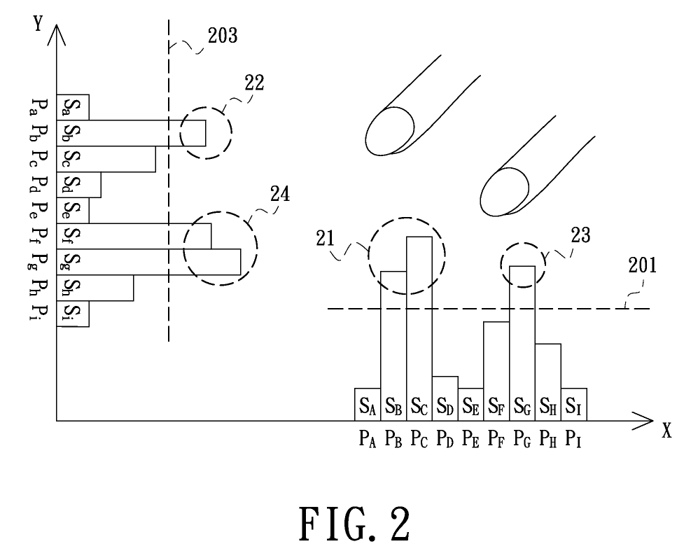

Referring to FIG. 2 that shows the energies distribution of multi-sensing points in multi-touching mode of the method for detecting touch position in accordance with the exemplary embodiment. FIG. 2 shows two touching points just taken for an exemplary embodiment. The number of the multi-touching points of the invention is not limited by the two touching points in FIG. 2. In FIG. 2, P_{A}, P_{B}, P_{C}, P_{D}, P_{E}, P_{F}, P_{G}, P_{H} and P_{I} respectively represent the positions of sensing points in alphabetical order from A through I in a sensing direction X. The positions of sensing points in alphabetical order from A through I respectively correspond to the sensing channels in alphabetical order from A through I in sensing direction X. The positions P_{A}, P_{B}, P_{C}, P_{D}, P_{E}, P_{F}, P_{G}, P_{H} and P_{I} are located and detected in succession. S_{A}, S_{B}, S_{C}, S_{D}, S_{E}, S_{F}, S_{G}, S_{H} and S_{I} respectively represent energies on the sensing points in alphabetical order from A though I in sensing direction X. Similarly, Pₐ, P_{b}, P_{c}, P_{d}, Pₑ, P_{f}, P_{g}, Pₕ and Pᵢ, respectively represent the positions of sensing points in alphabetical order from a through i in sensing direction Y. The positions of sensing points in alphabetical order from a through d respectively correspond to the sensing channels in alphabetical order from a through i in sensing direction Y. The positions Pₐ, P_{b}, P_{c}, P_{d}, Pₑ, P_{f}, P_{g}, Pₕ and Pᵢ, are located and detected in succession. Sₐ, S_{b}, S_{c}, S_{d}, Sₑ, S_{f}, S_{g}, Sₕ and Sᵢ respectively represent energies on the sensing points in alphabetical order from a though i in a sensing direction Y.

As shown in FIG. 2, the signals on positions P_{B}, P_{C} and P_{G} in sensing direction X respectively have energies S_{B}, S_{C} and S_{G} all above a preset threshold 201, the signals on positions P_{B}, P_{C} and P_{G} are described as first signals. The positions P_{B} and P_{C} are successive with each other, and non-successive with P_{G}. The first signals having energies S_{B} and S_{C} are assigned to be one group 21, the first signal having energy S_{G} is assigned to be another group 23. When calculate X-coordinate of the first touching point using the group 21, energies S_{A} and S_{D} of the signals on P_{A}, P_{D} and besides P_{B}, P_{C} are taken as weights for calculation. The signals on P_{A} and P_{D} respectively having energies S_{A} and S_{D} both below the preset threshold 201 are described as second signals. The first signals and the second signals corresponding to energies S_{A}, S_{B}, S_{C} and S_{D} together form a signal group. The X-coordinate of the first touching point can be calculated by an expression (2.1): (S_{A}×P_{A}+S_{B}×P_{B}+S_{C}×P_{C}+S_{D}×P_{D})/(S_{A}+S_{B}+S_{C}+S_{D}). According to the expression (2.1), the weights of energies S_{B}, S_{C}, S_{A}, S_{D} of the first signals and the second signals are associated with the positions P_{A}, P_{B}, P_{C} and P_{D} of the sensing points of the first signals and the second signals in sensing direction X, and the positions P_{A}, P_{B}, P_{C} and P_{D} of the sensing points of the first signals and the second signals in sensing direction X are sorted in a descending order or an ascending order according to the precedence of the positions of the sensing points where the first signals and the second signals being detected. That is, the value of the P_{A}, P_{B}, P_{C} and P_{D} are sorted in a descending order or an ascending order. In addition, in sensing direction X, the positions P_{A}, P_{D} of the sensing points where the second signals being detected are located at both sides of the positions P_{B}, P_{C} of the sensing points where the first signals being detected. The sensing points where the second signals being detected have an equal number at both sides of the sensing points where the first signals being detected in sensing direction X.

Further, when calculating X-coordinate of the second touching point using the group 23, energies S_{F} and S_{H} of the signals on P_{F} and P_{H} at both sides of P_{G} are taken as weights for calculation. The signals on P_{F} and P_{H} respectively having energies S_{F} and S_{H} both below the preset threshold 201 are described as second signals. The first signals and the second signals corresponding to energies S_{F}, S_{G}, and S_{H} together form another signal group. The X-coordinate of the touching point can be calculated by an expression (2.3): (S_{F}×P_{F}+S_{G}×P_{G}+S_{H}×P_{H})/(S_{F}+S_{G}+S_{H}). According to the expression (2.3), the weights of energies S_{F}, S_{G} of the first signals and S_{H} of the second signals are associated with the positions P_{F}, P_{G}, and P_{H} of the sensing points of the first signals and the second signals in sensing direction X, and the positions P_{F}, P_{G}, and Pₕ of the sensing points of the first signals and the second signals in sensing direction X are sorted in a descending order or an ascending order according to the precedence of the positions of the sensing points where the first signals and the second signals being detected. That is, the value of the P_{F}, P_{G}, and P_{H} are sorted in a descending order or an ascending order. In addition, the positions P_{F}, P_{H} of the sensing points of the second signals in sensing direction X are located at both sides of the positions P_{G} of the sensing points of the first signals in sensing direction X. The sensing points of the second signals have an equal number at both sides of the sensing points of the first signals in sensing direction X. It should be understood, in the embodiment, the energies S_{E} and S_{I} and the positions P_{E} and P_{I} of the sensing points corresponding to S_{E}, S_{I} in sensing direction X can also be applied into the expression (2.3) to calculate the X-coordinate of the second touching point. In other words, in sensing direction X, the number of the second signal(s) in a signal group can be set according to actual requirement.

Referring to FIG. 2 again, the signals on P_{b}, P_{f} and P_{g} in sensing direction Y respectively having energies S_{b}, S_{f} and S_{g} all above a preset threshold 203 are described as first signals. The positions P_{f} and P_{g} are successive with each other, and not successive with P_{b}. The first signals having energies S_{f} and S_{g} are assigned to be a same group 24, the first signal having energy S_{b} is assigned to be another group 22. When calculate Y-coordinate of the first touching point using the group 22, energies Sₐ and S_{c} of the signals on Pₐ and P_{c} at both sides of P_{b} are taken as weights for calculation. The signals on Pₐ and P_{c} respectively having energies Sₐ and S_{c} both below the preset threshold 203 are described as second signals. The first signals and the second signals corresponding to energies Sₐ, S_{b} and S_{c} together form a signal group. The Y-coordinate of the first touching point can be calculated by an expression (2.2): (Sₐ×Pₐ+S_{b}×P_{b}+S_{c}×P_{c})/(Sₐ+S_{b}+S_{c}). According to the expression (2.2), in sensing direction Y, the weights of energies Sₐ, S_{b}, S_{c} of the first signal and the second signals are associated with the positions Pₐ, P_{b} and P_{c} of the sensing points of the first signal and the second signals, and the positions Pₐ, P_{b} and P_{c} of the sensing points of the first signal and the second signals are sorted in a descending order or an ascending order according to the precedence of the positions of the sensing points where the first signals and the second signals being detected. That is, the value of the Pₐ, P_{b} and P_{c} are sorted in a descending order or an ascending order. In addition, in sensing direction Y, the positions Pₐ, P_{c} of the sensing points of the second signals are located at both sides of the position P_{b} of the sensing point of the first signals. The sensing points of the second signals have an equal number at both sides of the sensing point of the first signals in sensing direction Y.

Further, when calculating Y-coordinate of the second touching point using the group 24, energies Sₑ, Sₕ of the signals on Pₑ, Pₕ and beside P_{f}, P_{g} are taken as weights for calculation. The signals on Pₑ and Pₕ respectively having energies Sₑ and Sₕ both below the preset threshold 203 are described as second signals. The first signals and the second signals corresponding to energies Sₑ, S_{f}, S_{g} and Sₕ together form another signal group. The Y-coordinate of the second touching point can be calculated by an expression (2.4): (Sₑ×Pₑ+S_{f}×P_{f}+S_{g}×P_{g}+Sₕ×Pₕ)/(Sₑ+S_{f}+S_{g}+Sₕ). According to the expression (2.4), in sensing direction Y, the weights of energies S_{f}, S_{g} and Sₑ, Sₕ of the first signals and the second signals are associated with the positions Pₑ, P_{f}, P_{g} and Pₕ of the sensing points of the first signals and the second signals, and the positions Pₑ, P_{f}, P_{g} and Pₕ of the sensing points where the first signals and the second signals being detected are sorted in a descending order or an ascending order according to the precedence of the positions of the sensing points where the first signals and the second signals being detected. That is, the value of the Pₑ, P_{f}, P_{g} and Pₕ are sorted in a descending order or an ascending order. In addition, in sensing direction Y, the positions Pₑ, Pₕ of the sensing points where the second signals being detected are located at both sides of the positions P_{f} and P_{g} of the sensing points where the first signals being detected. The sensing points where the second signals being detected have an equal number at both sides of the sensing points where the first signals being detected. It should be understood, in the embodiment, the energies S_{d} and Sᵢ and the positions P_{d} and Pᵢ of the sensing points corresponding to S_{d}, Sᵢ in sensing direction Y can also be applied into the expression (2.4) to calculate the Y-coordinate of the second touching point. In other words, in sensing direction Y, the number of the second signal(s) in a signal group can be set according to actual requirement.

The relationship of above X-coordinates and Y-coordinates can be determined by reference of traditional ghost point eliminating means. For example, if a determined result of above embodiment by reference of traditional ghost point eliminating means is that, the groups 21 and 22 are a valid combination for a touching point, the groups 23 and 24 are a valid combination for another touching point, thus, the X-coordinate and Y-coordinate of the first touching point can be obtained by a combination of the groups 21 and 22, and the X-coordinate and Y-coordinate of the second touching point can be obtained by a combination of the groups 23 and 24. Thus, a two-dimensional coordinate of a plurality of touching points, that is, the X-coordinates and Y-coordinates of the plurality of touching points in the embodiment can be obtained.

In the embodiments, above energy of each the at least one first signal or the second signals can respectively be amplitude of a voltage or a current on the corresponding sensing point or of the corresponding signal.

As stated above, the exemplary embodiment of the present invention has a preset threshold, when a signal having energy above the preset threshold being sensed, the signal together with the other signal(s) that having energy below the preset threshold and having sensing points located beside the signal may be applied for a weighted average operation to calculate the coordinates of a single touching point, thus, the obtained result should be quite accurate. In addition, the exemplary embodiment of the present invention can also be used for calculating the coordinates of two or more touching points by group and weight, thus, the exemplary embodiment of the present invention is applicable for detection of multi-touching points.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for detecting touch position, comprising the steps of:
detecting a plurality of first sensing points for obtaining at least one first signal and a plurality of second signals, wherein the at least one first signal each has an energy above a first preset threshold, the second signals each has an energy below the first preset threshold, positions of the first sensing points where the second signals being detected are successive with a position(s) of the first sensing point(s) where the at least one first signal being detected; and
performing a weighted averaging operation applied to the energies of the at least one first signal and the second signals to obtain a result of the weighted averaging operation as a first dimension coordinate of a touching point, wherein weights of the respective energies of the at least one first signal and the second signals are associated with the positions of the first sensing points where the at least one first signal and the second signals being detected.

2. The method as claimed in claim 1, wherein the weights of the energies of the at least one first signal and the second signals are in a descending order or an ascending order according to the precedence of the positions of the first sensing points where the at least one first signal and the second signals are detected.

3. The method as claimed in claim 2, wherein the positions of the first sensing points where the second signals being detected are at both sides of the position(s) of the first sensing point(s) where the at least one first signal being detected.

4. The method as claimed in claim 3, wherein the first sensing points where the second signals being detected have an equal number at either side of the first sensing point(s) where the at least one first signal being detected.

5. The method as claimed in claim 1, further comprising steps of:
detecting a plurality of second sensing points for obtaining at least one third signal and a plurality of fourth signals on the second sensing points, wherein the at least one third signal each has an energy above a second preset threshold, the fourth signals each has an energy below the second preset threshold, positions of the second sensing points where the fourth signals being detected are successive with a position(s) of the second sensing point(s) where the at least one third signal being detected; and
performing a weighted averaging operation applied to the energies of the at least one third signal and the fourth signals to obtain a result of the weighted averaging operation as a second dimension coordinate of a touching point, wherein weights of the respective energies of the at least one third signal and the fourth signals are associated with the positions of the second sensing points where the at least one third signal and the fourth signals being detected.

6. The method as claimed in claim 5, wherein the weights of the energies of the at least one third signal and the fourth signals are in a descending order or an ascending order according to the precedence of the positions of the second sensing points where the at least one third signal and the fourth signals being detected.

7. The method as claimed in claim 6, wherein the positions of the second sensing points where the fourth signals being detected are at both sides of the position(s) of the second sensing point(s) where the at least one third signal being detected.

8. The method as claimed in claim 7, wherein the second sensing points where the fourth signals being detected have an equal number at both sides of the second sensing point(s) where the at least one third signal being detected.

9. The method as claimed in claim 1, wherein the energy of each the at least one first signal or the second signals is amplitude of a voltage or a current of the corresponding signal.

10. A method for detecting touch position, comprising the steps of:
detecting a plurality of first sensing points for obtaining a plurality of first signals on the first sensing points, wherein the first signals each has an energy above a first preset threshold;
sorting the first signals into a plurality of first groups, wherein the first sensing points where the first signals being detected having successive positions are sorted into one group, and the first sensing points where the first signals being detected having non-successive positions are sorted into another group; and
performing a weighted averaging operation applied to the energies of the first signals of each of the first group and a plurality of corresponding second signals having energies below the first preset threshold to obtain a result of the weighted averaging operation as a first dimension coordinate of a plurality of touching points,
wherein positions of the first sensing points where the first signals of each of the first groups being detected are successive with the positions of the first sensing points where the corresponding second signals of each of the first groups being detected, and weights of the respective energies of the first signals and the corresponding second signals of each of the first groups are associated with the positions of the first sensing points where the first signals and the second signals of each the first group being detected.

11. The method as claimed in claim 10, wherein the weights of the energies of the first signals and the corresponding second signals of each the first group are in a descending order or an ascending order according to the precedence of the positions of the first sensing points where the first signals and the second signals being detected.

12. The method as claimed in claim 11, wherein the positions of the first sensing points where the corresponding second signals of one of the first groups being detected are at both sides of the positions of the first sensing points where the first signal being detected.

13. The method as claimed in claim 12, wherein the first sensing points where the corresponding second signals of one of the first groups being detected have an equal number at both sides of the first sensing points where the first signals being detected.

14. The method as claimed in claim 10, further comprising steps of:
detecting a plurality of second sensing points for obtaining a plurality of third signals on the second sensing points, wherein third signals each has an energy above a second preset threshold;
sorting the third signals into a plurality of second groups, wherein the second sensing points where the third signals being detected having successive positions are sorted into a same group, and the second sensing points where the third signals being detected having non-successive positions are sorted into another groups; and
performing a weighted averaging operation applied to the energies of the third signals of each of the second groups and a plurality of corresponding fourth signals having energies below the second preset threshold to obtain a result of the weighted averaging operation as a second dimension coordinate of one of a plurality of touching points,
wherein positions of the second sensing points where the third signals of each of the second groups being detected are successive with the positions of the second sensing points where the corresponding fourth signals of the second groups being detected, and weights of the respective energies of the third signals and the corresponding fourth signals of each of the second groups are associated with the positions of the second sensing points where the third signals and the fourth signals being detected.

15. The method as claimed in claim 14, wherein the weights of the energies of the third signals and the corresponding fourth signals of each the second group are in a descending order or an ascending order according to the precedence of the positions of the second sensing points where the third signals and the fourth signals being detected.

16. The method as claimed in claim 15, wherein the positions of the second sensing points where the corresponding fourth signals of one of the second groups being detected are at both sides of the positions of the second sensing points where the third signals being detected.

17. The method as claimed in claim 16, wherein the second sensing points where the corresponding fourth signals of one of the second groups being detected have an equal number at both sides of the second sensing points where the third signals being detected.

18. A method for detecting touch position, comprising steps of:
detecting a plurality of first sensing points for obtaining a plurality of first signal groups on the first sensing points, wherein each of the first signal groups includes at least one first signal and a plurality of corresponding second signals, the at least one first signal each has an energy above a first preset threshold, the corresponding second signals each has an energy below the first preset threshold, positions of the first sensing points where the corresponding second signals of each first signal group being detected are successive with a position(s) of the first sensing point(s) where the at least one first signal being detected; and
performing a weighted averaging operation applied to the energies of the at least one first signal and the corresponding second signals of each first signal group to obtain a result of the weighted averaging operation as a first dimension coordinate of one touching point of a plurality of touching points, wherein weights of the respective energies of the at least one first signal and the corresponding second signals of each first signal group are associated with the positions of the first sensing points where the at least one first signal and the corresponding second signals being detected.

19. The method as claimed in claim 18, wherein if the number of the at least one first signal is more than two, the positions of the first sensing points where the more than two first signals being detected are successive.

20. The method as claimed in claim 18, wherein the weights of the energies of the at least one first signal and the corresponding second signals of each of the first signal groups are in a descending order or an ascending order according to the precedence of the positions of the first sensing points where the at least one first signals and the corresponding second signals of the first signal groups.

21. The method as claimed in claim 18, further comprising steps of:
detecting a plurality of second sensing points for obtaining a plurality of second signal groups on the first sensing points, wherein each of the second signal groups includes at least one third signal and a plurality of corresponding fourth signals, the at least one third signal each has an energy above a second preset threshold, the corresponding fourth signals each has an energy below the second preset threshold, positions of the second sensing points where the corresponding fourth signals of each second signal group being detected are successive with a position(s) of the sensing point(s) where the at least one third signal being detected; and
performing a weighted averaging operation applied to the energies of the at least one third signal and the corresponding fourth signals of each second signal group to obtain a result of the weighted averaging operation as a second dimension coordinate of one touching point of a plurality of touching points, wherein weights of the respective energies of the at least one third signal and the corresponding fourth signals of each second signal group are associated with the positions of the second sensing points where the at least one third signal and the corresponding fourth signals being detected.

22. The method as claimed in claim 21, wherein if the number of the at least one third signal is more than two, the positions of the second sensing points where the more than two third signals being detected are successive.

23. The method as claimed in claim 21, wherein the weights of the energies of the at least one third signal and the corresponding fourth signals of each of the second signal groups are in a descending order or an ascending order according to the precedence of the positions of the second sensing points where the at least one third signals and the corresponding fourth signals of the second signal groups.
